(19) United States
(12) Patent Application Publication
(10) Pub. No.: US 2020/0072382 A1
(43) Pub. Date: Mar. 5, 2020

(54) Indoor combustible pipeline encryption protection device

(71) Applicant: Xiaofeng Zhu, Shaoxing City (CN)

(72) Inventor: Xiaofeng Zhu, Shaoxing City (CN)

(21) Appl. No.: 16/677,681

(22) Filed: Nov. 8, 2019

(30) Foreign Application Priority Data
Jul. 2, 2019 (CN) 2019105910561

(51) Int. Cl. F16K 35/08; F17D 5/00; F17D 5/06

(52) U.S. Cl. CPC F16K 35/08; F17D 5/06; F17D 5/005

(57) ABSTRACT

The invention discloses an indoor combustible pipeline encryption protection device, including an upper valve body, the upper valve body is provided with a rotatable rotary hollow shaft, the outer wall of the rotary hollow shaft is provided with a thread, and the outer wall of the rotary hollow shaft is connected with the inner wall of the upper valve body through a thread. The invention has the advantages of simple structure, convenient maintenance, convenient use, fast and convenient sealing of the indoor pipeline gas pipeline, at the same time, encryption protection, preventing the indoor pipeline from being sealed children or outsiders misoperate the gas valve, which leads to gas leakage accident, which can provide security for indoor personnel.

### CROSS-REFERENCE TO RELATED APPLICATIONS

The present application claims priority from Chinese application No. 2019105910561 filed on Jul. 2, 2019 which is hereby incorporated by reference in its entirety.

### TECHNICAL FIELD

The present invention relates to the field of indoor safety protection, in particular to an indoor combustible pipeline encryption protection device.

### BACKGROUND OF THE INVENTION

Nowadays, the indoor pipeline gas is more and more popular. However, due to people's negligence or misoperation, the indoor gas leakage and explosion accidents happen frequently. Most of the gas leakage is caused by the loose valve or poor sealing effect. Therefore, it is necessary to design a device which can seal the indoor pipeline gas quickly and conveniently, and at the same time carry out encryption protection, so as to prevent the indoor gas leakage and explosion misoperation of gas valve by children or outsiders leads to gas leakage accident, which provides reliable guarantee for the safety of indoor personnel.

### BRIEF SUMMARY OF THE INVENTION

The technical problem:

Because the valve seal is not tight or the human operation is wrong, it is very easy to cause gas leakage, which leads to greater harm.

In order to solve the above problems, an indoor combustible pipeline encryption protection device is designed in this example, including the upper valve body, the upper valve body is provided with a rotatable hollow shaft, the outer wall of the rotating hollow shaft is provided with threads, the outer wall of the rotating hollow shaft is connected with the inner wall of the upper valve body through threads, and the upper valve body is lower The left end of the upper valve body is provided with a rotatable fastening bolt, the lower end of the fastening bolt is provided with a fastening nut, the upper valve body and the lower valve body are fastened at the lower end of the upper valve body through the fastening nut and the fastening bolt, the left end of the lower valve body is communicated with an air inlet pipe with an opening to the left, and the right end of the lower valve body is communicated with an opening The lower end of the rotary hollow shaft is located in the outlet pipe, the lower end of the rotary hollow shaft is connected with a valve locking mechanism which can lock the valve, the top end of the rotary hollow shaft is fixed with a valve connecting block, and the upper end of the valve connecting block is fixed with a valve connecting block A rotary handle is fixedly provided. When the rotary handle is screwed, the rotary hollow shaft can be driven to rotate. A password lock chamber is connected between the upper valve body and the lower valve body. The password lock chamber has an opening to the left. The password lock chamber is provided with a password lock mechanism, which can control the opening or locking of the valve.

Wherein, the cipher lock mechanism comprises a cipher shaft which is rotationally connected between the front and rear inner walls of the cipher lock chamber, the cipher ring is fixedly arranged symmetrically on the outer wall of the cipher shaft, the outer wall circular array of the cipher ring is provided with six, the front and rear inner walls of the cipher lock chamber are rotationally connected with a lock mandrel, the lock mandrel is arranged on the right side of the cipher shaft, and the front and rear outer walls of the lock mandrel The symmetrical solid is provided with a lock core gear, the outer wall circular array is provided with six second grooves, the lock core gear can be meshed with the password ring, the lock core gear is internally provided with a lock core electromagnet, the outer wall of the lock core electromagnet is provided with a circular array, and the elastic solid connection is provided with six lock core spring, one end of the lock core spring away from the lock core electromagnet is fixedly connected with a magnetic slider, and the magnetic one side of the sliding block away from the lock cylinder gear is fixedly provided with a lock cylinder sliding block, the lock cylinder sliding block can slide between the first groove and the second groove, the outer wall of the lock cylinder shaft is fixedly provided with a lock gear, the lock gear is located between the lock cylinder gear, the right side of the lock gear is in contact with a sliding lock pin, the front wall of the lock pin is fixedly provided with a reset rod, and the front wall of the lock pin is fixedly provided with a reset rod The upper side of the lock pin is provided with a third groove, the third groove and the upper wall of the lock pin are fixedly provided with splines, the right end of the splines is elastically connected with a lock pin spring, the right end of the lock pin spring is fixedly connected with the third groove, the right end of the lock pin is connected with the sealing mechanism, and the lock pin can control the sealing mechanism to seal the valve.

Wherein, the sealing mechanism comprises a central control pin arranged in the rotary hollow shaft, the top end of the central control pin is in contact with the lock pin, the inner wall of the rotary hollow shaft is provided with a fourth groove, the lower wall of the fourth groove is fixedly provided with a central return spring, the top end of the central return spring is elastically connected with the central control pin, and the air outlet pipe is located in the A left and right symmetrical sealing cover is fixedly arranged on the outer wall of the central control pin, a fifth groove is arranged on the lower wall, the lower end of the sealing cover can fit with the fifth groove to play a sealing role, a limited block is fixedly arranged on the outer wall of the rotary hollow shaft, and the limited block can contact with the inner wall of the gas outlet pipe to play a limiting role.

Wherein, the valve locking mechanism comprises a locking pin symmetrically arranged at the bottom end of the rotary hollow shaft left and right, the locking pin outer wall is elastically provided with a locking pin return spring, the locking pin return spring is elastically connected at one side far away from the central control pin on the inner wall of the rotary hollow shaft, the locking pin is close to one side of the central control pin and is in phase with the central control pin when the central control pin moves downward, the locking pin can be squeezed so that the locking pin slides out towards both ends of the rotating hollow shaft to lock the valve.

The invention has the advantages of simple structure, convenient maintenance, convenient use, fast and convenient sealing of indoor pipeline gas pipeline, encryption protection at the same time, preventing indoor children or outsiders from misoperation of gas valve, causing gas leakage accident, and providing safety guarantee for indoor personnel.

### BRIEF DESCRIPTION OF THE DRAWINGS

In order to explain the embodiments of the invention or the technical solutions in the prior art more clearly, the following will give a brief introduction to the drawings needed in the embodiments or the prior art description.

FIG. 1 is the overall schematic structural diagram of the indoor combustible pipeline encryption protection device;

FIG. 2 is the structural diagram of “A-A” direction in FIG. 1;

FIG. 3 is an enlarged diagram of the “B” structure of FIG. 1;

FIG. 4 is an enlarged diagram of the “C” structure of FIG. 1.

### DETAILED DESCRIPTION OF THE INVENTION

The invention relates to an indoor combustible pipeline encryption protection device, which is mainly used in the field of indoor safety protection. The invention will be further described in combination with the drawings of the invention:

An indoor combustible pipeline encryption protection device includes an upper valve body 14, wherein the upper valve body 14 is provided with a rotatable rotating hollow shaft 13, the outer wall of the rotating hollow shaft 13 is provided with a thread, the outer wall of the rotating hollow shaft 13 is connected with the inner wall of the upper valve body 14 through a thread, the lower valve body 19 is provided for the lower end of the upper valve body 14 contacting, and the left end of the upper valve body 14 is provided with a rotatable hollow shaft 13 The lower end of the rotating fastening bolt 15 is sleeved with a fastening nut 18, the upper valve body 14 and the lower valve body 19 are fastened at the lower end of the upper valve body 14 through the fastening nut 18 and the fastening bolt 15, the left end of the lower valve body 19 is communicated with an air inlet pipe 21 with an opening to the left, the right end of the lower valve body 19 is communicated with an air outlet pipe 22 with an opening to the right, the rotating The lower end of the hollow shaft 13 is provided with a sealing mechanism 401 which can seal the valve, the sealing mechanism 401 is located in the gas outlet pipe 22, the lower end of the rotary hollow shaft 13 is located in the air inlet pipe 21 and is connected with a valve locking mechanism 402 which can lock the valve, the top end of the rotary hollow shaft 13 is fixed with a valve connecting block 12, and the upper end of the valve connecting block 12 is fixed with a rotary hollow shaft 13 Handle 11, when rotating the rotating handle 11, can drive the rotating hollow shaft 13 to rotate, the password lock chamber 300 is connected between the upper valve body 14 and the lower valve body 19, the password lock chamber 300 is opened to the left, the password lock chamber 300 is equipped with the password lock mechanism 301, and the password lock mechanism 301 can control the opening or locking of the valve.

According to the embodiment, the cipher lock mechanism 301 is described in detail below. The cipher lock mechanism 301 includes a cipher shaft 17 which is rotationally connected between the front and rear inner walls of the cipher lock chamber 300. The cipher ring 16 is symmetrically fixed on the outer wall of the cipher shaft 17, and the outer wall circular array of the cipher ring 16 is provided with six 801S. The rotation connection between the front and rear inner walls of the cipher lock chamber 300 is provided with a lock The core shaft 25 is arranged on the right side of the cipher shaft 17, the lock core gear 24 is fixedly and symmetrically arranged on the outer wall of the lock core shaft 25, the annular array of the outer wall of the 24 is provided with six second grooves 802, the lock core gear 24 can mesh with the cipher ring 16, the lock core electromagnet 26 is fixedly arranged in the lock core gear 24, the annular array on the outer wall of the lock core electromagnet 26 is fixedly and elastically connected Six lock core springs 29, one end of the lock core spring 29 far away from the lock core electromagnet 26 is fixedly connected with a magnetic sliding block 28, one side of the magnetic sliding block 28 far away from the lock core gear 24 is fixedly provided with a lock core sliding block 27, the lock core sliding block 27 can slide between the first groove 801 and the second groove 802, the outer wall of the lock core shaft 25 is fixedly provided with a lock gear 23, and the lock gear 23 is located on the outer wall of the lock core shaft 25 Between the lock cylinder gears 24, the right side of the lock gear 23 is contacted with a sliding lock pin 33, the front wall of the lock pin 33 is fixedly provided with a reset rod 32, the upper side of the lock pin 33 is provided with a third groove 806, the third groove 806 is located in the lock pin 33, and the upper wall of the lock pin 33 is fixedly provided with a spline 34, the right end of the spline 34 is elastically connected with a lock pin spring 35, and the right end of the lock pin spring 35 is fixedly connected with the lock pin spring 35 The third groove 806, the right end of the lock pin 33 is connected with the sealing mechanism 401, and the lock pin 33 can control the sealing mechanism 401 to seal the valve.

According to the embodiment, the sealing mechanism 401 includes a central control pin 36 arranged in the rotating hollow shaft 13, the top end of the central control pin 36 is in contact with the locking pin 33, the inner wall of the rotating hollow shaft 13 is provided with a fourth groove 803, the lower wall of the fourth groove 803 is fixedly provided with a central return spring 37, and the central return spring The top end of the spring 37 is elastically connected with the central control pin 36, the gas outlet pipe 22 is fixedly provided with a sealing cover 38 symmetrically on the outer wall of the central control pin 36, the lower wall of the 22 is provided with a fifth groove 804, and the lower end of the sealing cover 38 can fit with the fifth groove 804 to play a sealing role, the outer wall of the rotary hollow shaft 13 is fixedly provided with a limited block 39, and the limit block 39 can it is in contact with the inner wall of the gas outlet pipe 22 and plays a limiting role.

According to the embodiment, the valve locking mechanism 402 is described in detail below. The valve locking mechanism 402 includes a locking pin 42 symmetrically arranged at the bottom end of the rotating hollow shaft 13 on the left and right. The locking pin 42 is elastically provided with a locking pin return spring 41 on the outer wall, and the locking pin return spring 41 is elastically connected and fixed in the rotating hollow shaft 13 on one side away from the central control pin 36 On the wall, the locking pin 42 is close to one side of the central control pin 36 and is in contact with the central control pin 36. When the central control pin 36 moves downward, the locking pin 42 can be squeezed so that the locking pin 42 slides out towards both ends of the rotating hollow shaft 13 and locks the valve door.

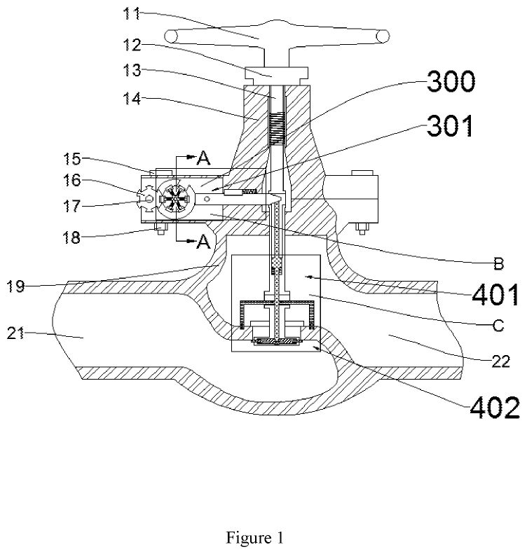

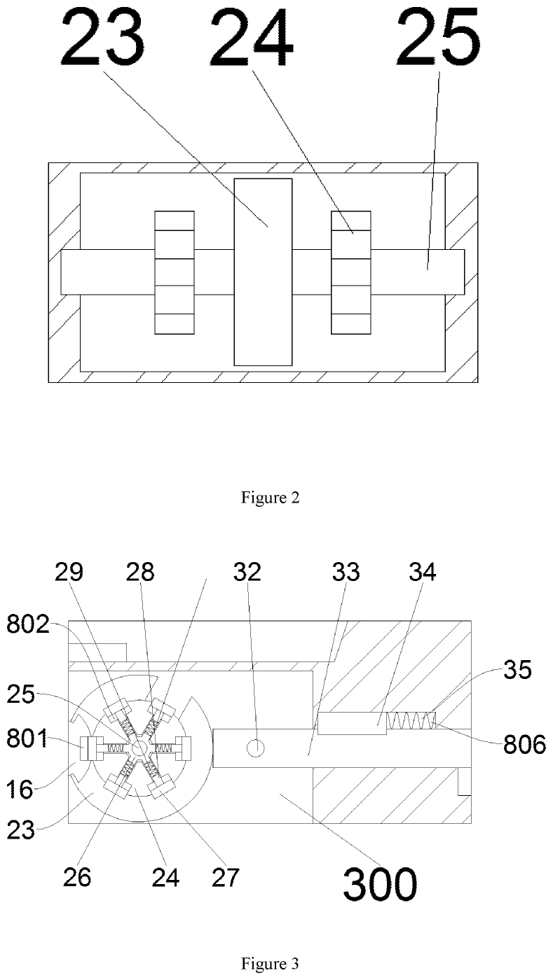

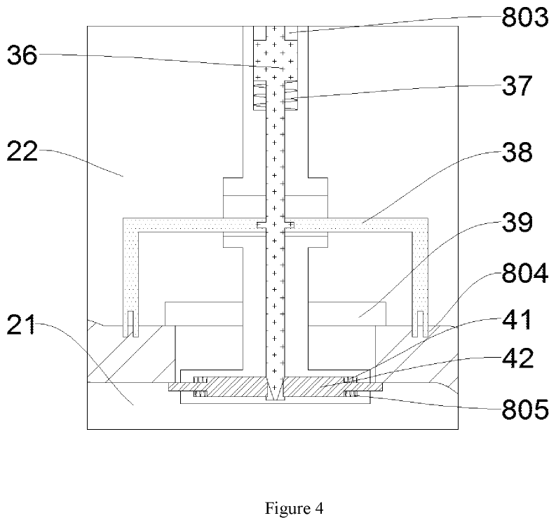

The operation steps of an indoor combustible pipeline encryption protection device in this paper are described in detail as follows in combination with FIGS. 1 to 4:

When the valve needs to be opened, first turn the password Ring 16 to the unlocking position, at this time, the password ring 16 drives the lock cylinder slider 27 to rotate, the lock cylinder slider 27 drives the lock cylinder shaft 25 to rotate, the lock cylinder shaft 25 drives the lock gear 23 to rotate to the specified unlocking angle, at this time, under the elastic force of the lock pin spring 35, drive the spline 34 and the lock pin 33 to slide to the left, so that the left end of the lock pin 33 slides into the lock gear 23 In the groove, the right end of the lock pin 33 slides away from the rotating hollow shaft 13, so that the central control pin 36 slides upward under the elastic force of the central return spring 37, and the central return spring 37 drives the seal cover 38 to slide upward, so that the lower end of the seal cover 38 is separated from the lower valve body 19, and the valve is unsealed. At the same time, the bottom of the central return spring 37 slides upward, so that the lock pin 42 slides under the elastic force of the return spring 41 of the lock pin The rotating hollow shaft 13 slides towards the inside of the rotating hollow shaft 13 to release the locking state of the device. At this time, the rotating handle 11 is screwed, which drives the rotating hollow shaft 13 to rotate through the valve connecting block 12. The rotating hollow shaft 13 slides upward under the action of the inner wall thread of the upper valve body 14, so that the air inlet pipe 21 is connected with the air outlet pipe 22. When the valve needs to be closed, the rotating handle 11 is screwed in the opposite direction The rotating handle 11 drives the rotating hollow shaft 13 to rotate through the valve connecting block 12, and the rotating hollow shaft 13 slides downward. When the limit block 39 is against the air inlet pipe 21, the rotating handle 11 cannot continue to rotate. At this time, the reset lever 32 slides to the right, so that the reset lever 32 compresses the central control pin 36 and moves downward, so that the seal cover 38 fits the lower wall of the air outlet pipe 22, and the central reset bullet The spring 37 compresses the locking pin 42, so that the locking pin 42 slides out of the rotating hollow shaft 13 and contacts with the upper wall of the air inlet pipe 21. At this time, turn the password Ring 16, so that the password Ring 16 drives the lock cylinder gear 24 to rotate through the lock cylinder slider 27, the lock cylinder gear 24 drives the lock cylinder shaft 25 to rotate, the lock cylinder shaft 25 drives the lock gear 23 to rotate, so that the groove on the lock gear 23 and the left end of the lock pin 33 are misaligned, so that when it is necessary to change the valve password, when the valve is unlocked, the lock cylinder electromagnet 26 in the lock cylinder gear 24 is energized, so that the lock cylinder electromagnet 26 attracts the magnetic slider 28 to slide inwards through the lock cylinder spring 29, and the magnetic slider 28 drives the lock cylinder slider 27 to slide inwards, so that the lock cylinder slider 27 and the password ring 16 are separated When the password ring 16 is turned to change the password, the lock cylinder electromagnet 26 is powered off, and the password of the valve password lock has been modified.

The invention has the advantages of simple structure, convenient maintenance, convenient use, fast and convenient sealing of indoor pipeline gas pipeline, encryption protection at the same time, preventing indoor children or outsiders from misoperation of gas valve, causing gas leakage accident, and providing safety guarantee for indoor personnel.

The above is only the specific embodiment of the invention, but the scope of protection of the invention is not limited to this. Any change or replacement without thinking of creative labor shall be covered in the scope of protection of the invention. Therefore, the scope of protection of the invention shall be subject to the scope of protection defined in the claims.

1. An indoor combustible pipeline encryption protection device, comprising an upper valve body is provided with a rotatable rotary hollow shaft, the outer wall of the rotary hollow shaft is provided with threads, and the outer wall of the rotary hollow shaft is connected with the inner wall of the upper valve body through threads;
The lower end of the upper valve body is in contact with the lower end of the upper valve body, the left end of the upper valve body is provided with a rotatable fastening bolt, the lower end of the fastening bolt is sleeved with a fastening nut, the upper valve body and the lower valve body are fastened at the lower end of the upper valve body through the fastening nut and the fastening bolt;
The left end of the lower valve body is communicated with an air inlet pipe with an opening to the left, the right end of the lower valve body is communicated with an air outlet pipe with an opening to the right, the lower end of the rotary hollow shaft is provided with a sealing mechanism which can seal the valve, the sealing mechanism is located in the air outlet pipe, the lower end of the rotary hollow shaft is located in the air inlet pipe, and is connected with a sealing mechanism which can lock the valve valve locking mechanism;
The top end of the rotary hollow shaft is fixedly provided with a valve connecting block, and the upper end of the valve connecting block is fixedly provided with a rotary handle;
A password lock cavity is arranged between the upper valve body and the lower valve body, the password lock cavity opening is left, and the password lock cavity is provided with a password lock mechanism.

2. The indoor combustible pipeline encryption protection device as defined in claim 1, wherein The cipher lock mechanism comprises a cipher shaft which is rotationally connected between the front and rear inner walls of the cipher lock chamber, a cipher ring is fixedly symmetrically arranged on the outer wall of the cipher shaft, six circular arrays of the outer wall of the cipher ring are arranged, a lock core shaft is rotationally connected between the front and rear inner walls of the cipher lock chamber, the lock core shaft is arranged on the right side of the cipher shaft, and the outer wall of the lock core shaft is symmetrically arranged A lock core gear is fixedly provided, the outer wall annular array is provided with six second grooves, the lock core gear can mesh with the password ring;
The lock core gear is fixedly provided with a lock core electromagnet, the outer wall of the lock core electromagnet is annular array and elastically fixedly connected with six lock core springs, the end of the lock core spring far away from the lock core electromagnet is fixedly connected with a magnetic slider, the side of the magnetic slider far away from the lock core gear is fixedly provided with a lock core slider, the lock core slider can be between the first groove and the second groove slide;
The outer wall of the lock core shaft is fixedly provided with a locking gear, the locking gear is located between the lock core gears, the right side of the locking gear is contacted with a sliding lock pin, the front wall of the lock pin is fixedly provided with a reset rod, the upper side of the lock pin is provided with a third groove, the third groove and the upper wall of the lock pin are fixedly provided with a spline, the right end of the spline is elastically connected with a lock pin The right end of the locking pin spring is fixedly connected with the third groove, and the right end of the locking pin is connected with the sealing mechanism.

3. The indoor combustible pipeline encryption protection device as defined in claim 2, wherein The sealing mechanism comprises a central control pin arranged in the rotary hollow shaft, the top end of the central control pin is in contact with the lock pin, the inner wall of the rotary hollow shaft is provided with a fourth groove, the lower wall of the fourth groove is fixedly provided with a central return spring, the top end of the central return spring is elastically connected with the central control pin, and the air outlet pipe is located in the center A left and right symmetrical sealing cover is fixedly arranged on the outer wall of the control pin, the lower wall is provided with a fifth groove, and the lower end of the sealing cover can fit the fifth groove;
A limited block is fixed on the outer wall of the rotating hollow shaft, and the limited block can contact with the inner wall of the gas outlet pipe.

4. The indoor combustible pipeline encryption protection device as defined in claim 1, wherein The valve locking mechanism comprises a locking pin symmetrically arranged at the bottom end of the rotary hollow shaft on the left and right sides, the locking pin outer wall is elastically provided with a locking pin return spring, the locking pin return spring is fixed on the inner wall of the rotary hollow shaft on the side far away from the central control pin, the locking pin is close to the side of the central control pin, and is in contact with the central control pin.
